(19) United States
(12) Patent Application Publication
(10) Pub. No.: US 2018/0306451 A1
(43) Pub. Date: Oct. 25, 2018

(54) THE REMOTE CONTROL OF NETWORKS OF HEAT-PUMP SYSTEMS FOR THE PURPOSE OF DEMAND SIDE MANAGEMENT

(71) Applicants: Alastair Gordon Laurence Hunter, Isle of Wight (GB); Arron Grist, Isle of Wight (GB)

(72) Inventors: Alastair Gordon Laurence Hunter, Isle of Wight (GB); Arron Grist, Isle of Wight (GB)

(21) Appl. No.: 15/752,803

(22) PCT Filed: Aug. 15, 2016
(86) PCT No.: PCT/GB2016/052528

§ 371 Date: Feb. 14, 2018

(30) Foreign Application Priority Data
Aug. 14, 2015 (GB) 1514538.6

(51) Int. Cl. F24D 19/10; G05B 15/02; F24D 3/18; F24D 11/00

(52) U.S. Cl. CPC F24D 19/1078; G05B 15/02; F24D 19/1081; F24D 11/003; F24D 11/004; F24D 3/18

(57) ABSTRACT

The remote control of networks of heat-pump systems, in particular where thermal stores are used, for the purpose of demand side management. A heat generating system comprising a heat pump, electrical immersion elements, thermal stores, pumps, heat exchangers, a solar collector, a software driven control system, a 5 means of remote control and a local control network linking local systems. This provides the means to be able to remotely control the timing and quantity of energy drawn from the grid in order to provide instantaneously controllable electrical demand for the purposes of grid balancing whilst maintaining a continuous supply of heat to the building or process for which it is built.

This invention relates to the remote control of networks of heat-pump systems, in particular where thermal stores are used, for the purpose of demand side management.

Electricity is generally distributed through a network, the electricity grid. In order to maintain supply there are numerous power generation plants distributed geographically. In order to maintain a continuous supply of electricity throughout the grid, system balancing is required whereby the base load is supplied by a base load generation plant, which is slow to respond to changes, and the fluctuating load is supplied by rapid response power generation plant. Electricity generation now incorporates many energy sources including ‘renewables’ and this creates another level of system balancing due to the intermittent generation nature of these sources. Unless there is a significant level of responsive or controllable demand, a larger system margin is required to cope with these fluctuations, in particular if there is unavailability of conventional generation or excess generation by the renewables generators.

Thus, renewables (and by definition intermittent generation) introduce another level of factors into the calculations needed to ensure that sufficient system margin is maintained.

The purpose of this invention is to introduce a significant level of demand side management through energy storage, remotely controlled by the energy generation or distribution system, in order to accommodate short term energy surpluses as well as demand side management involving turning off significant load on demand.

According to the present invention there is provided a heat generating system comprising a water-to-water heat pump, first and second electrical immersion elements for respective first and second low and high temperature thermal stores, pumps, heat exchangers, a ‘solar’ collector, a software driven control system, a means of remote control, and a local control network linking local systems.

A specific embodiment of the invention will now be completely and clearly described, by way of example only, with reference to the accompanying drawings in which:

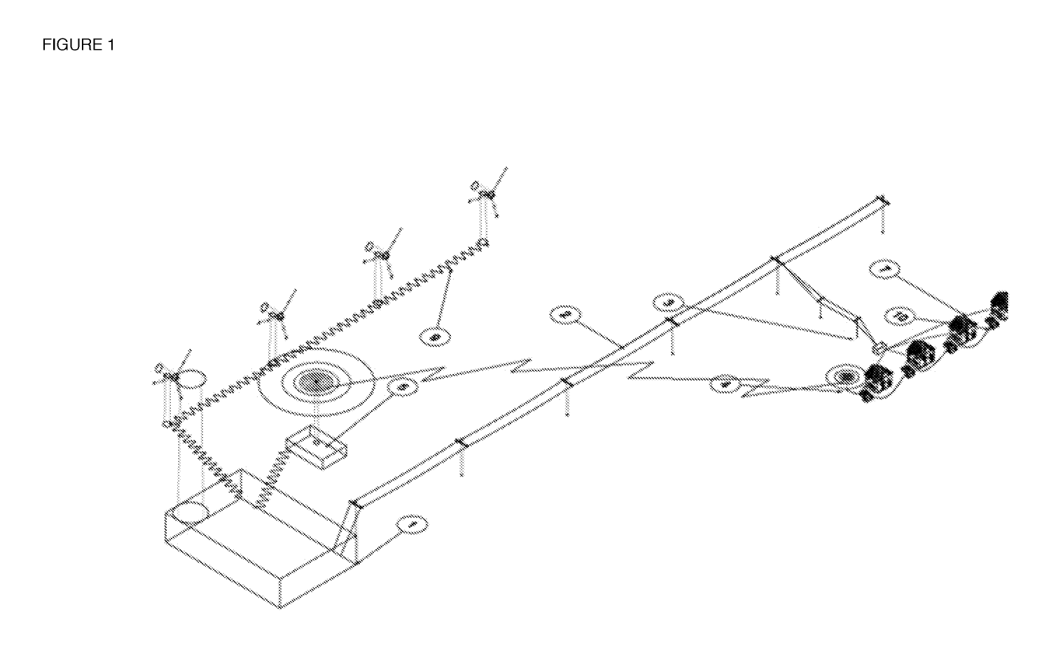

FIG. 1 shows an overview of a grid together with a small local heat network,

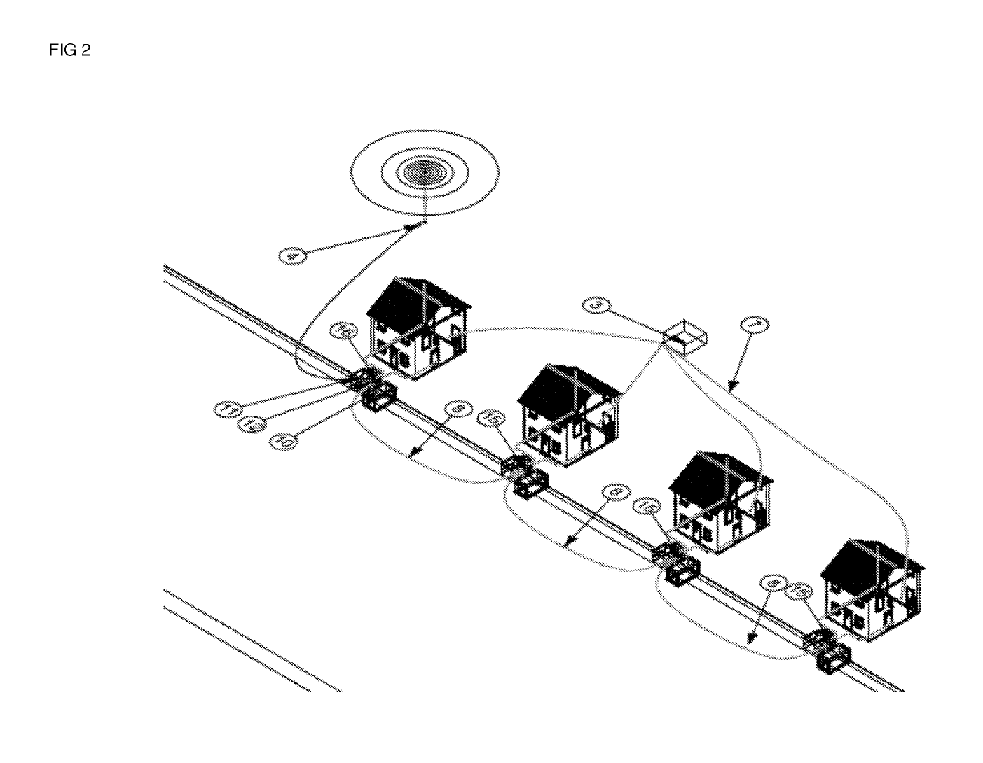

FIG. 2 shows a number of heat generating systems with a local control network, and

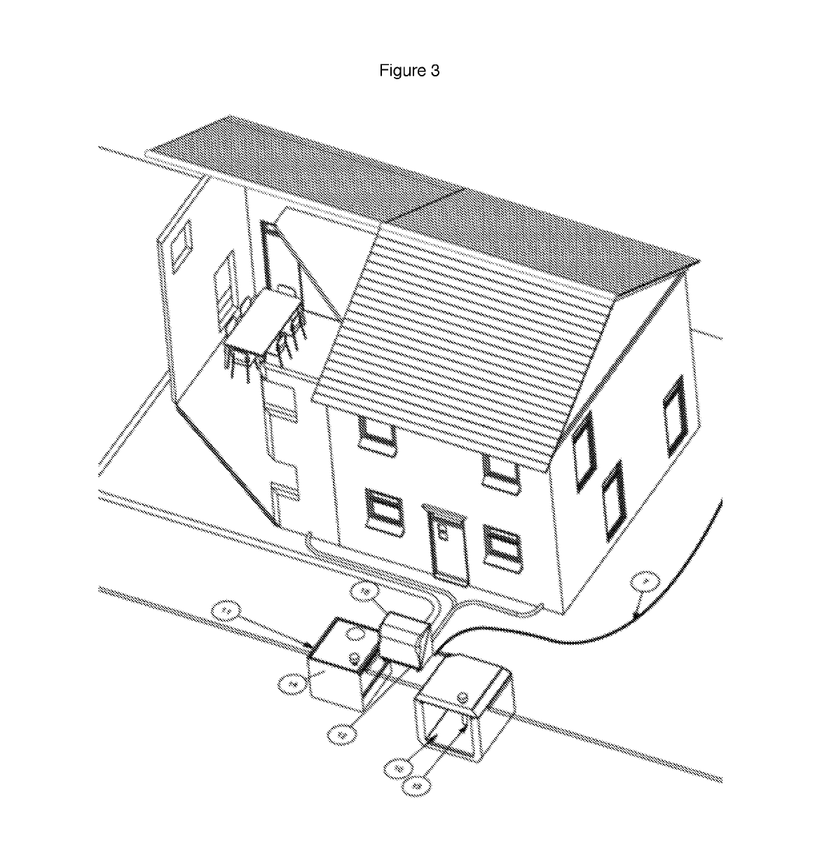

FIG. 3 shows a heat generating system

Referring to the drawings, a grid consists of base load generation plant 1, power generation by renewables 6, grid control room 5 and a distribution network including a high voltage grid 2 together with low voltage local distribution networks 3. The heat generating system comprises a ‘cold’ (low temperature) store 11, which is a thermal energy source for a water-to-water heat-pump 12 and a ‘hot’ (high temperature) store 10, which is a thermal sink for the water-to-water heat pump 12, and which forms the thermal energy source for the building or process for which energy is being supplied as heating and/or hot water. This system provides thermal energy for the ‘cold’ store 11 via a ‘solar’ collector and has a temperature range which varies from around −11° C. to around +18° C. which is the satisfactory operational range for the evaporator circuit of the water-to-water heat pump 12. However this ‘cold’ store 11 could also gain heat directly from the electrical supply grid by using a resistive element (such as an immersion element) 14 in the tank to supply this energy. This provides a significant electrical load on instantaneous demand.

One or more pumps and heat exchangers are also provided in the heating system circuit between the ‘solar’ collector and the heat distribution system where heating and/or hot water is required.

The ‘solar’ collector is preferably of a relatively large surface area such as a roof or another surface of a building. Preferably, such a solar collector is made up of a plurality of interconnected elongate heat collecting panels for carrying a heat transfer fluid and which can include a photo-voltaic module mounted thereto in order to achieve the collection of energy from environmental solar energy by way of both solar photo-voltaic and solar thermal means. Any such photo-voltaic module is advantageously mounted or embedded in a recessed portion of an outer surface of the heat collecting panel. In this way, a battery storage system can be charged to store energy from the ‘solar’ collector and any excess energy generated can be sent back to the grid.

The ‘hot’ store 10 when provided with sufficient capacity also provides significant energy storage for the building or process to utilise as required. The heat delivered in this way is disconnected from the operation of the heat-pump 12 thus allowing the operation of the heat-pump 12 to be managed independently. This thermal store could also gain heat directly from the electrical supply grid by using a resistive element (such as an immersion element) 13 in the tank to supply this energy.

The heat pump operation is normally arranged for local control, by a software driven system controller 15 (see FIG. 3). This manages the operation of the heat pump 12 based on maximising renewable energy collection and minimising the operation of the heat pump 12.

The operation of the heat pump 12 can also be remotely controlled by the grid operator in the grid control room 5 via a remote control link 4.

In a scenario where there are multiple systems installed in a particular locale, these systems can be arranged in a local control network 7 linking the local systems via connections 8 and, advantageously, a heat distribution manifold to operate as a group with a master control system 16 associated with the system controller 15 (see FIG. 2).

This master control system 16 can be remotely accessed by the grid operator using a dedicated wireless connection 4 or via an internet connection 4 or via a GSM communications network.

The local control network 7 can be fitted with oversized high temperature thermal stores 10 and/or oversized low temperature thermal stores 11. A heat generating system including an oversized low temperature thermal store 11 and/or an oversized high temperature thermal store 10 enables a significant proportion of the energy capacity to be dedicated to remote control ensuring continuity of thermal supply to a building or process.

Management of the operation of the high and low temperature thermal stores (10, 11) can be arranged with priorities allowing the software driven control system 15 to override the master controller 16 when required.

The local control network 7 may comprise a series of air source heat pumps, a series of ground source heat pumps, a series of water source heat pumps, or a combination thereof.

This heat generating system provides the means to be able to remotely control the timing and quantity of energy drawn from the grid in order to provide instantaneously controllable electrical demand for the purposes of grid balancing whilst maintaining a continuous supply of heat to the building or process for which it is built.

1. A heat generating system comprising a water-to-water heat pump (12), first and second electrical immersion elements (13, 14) for respective first and second low and high temperature thermal stores (10, 11), pumps, heat exchangers, a ‘solar’ collector, a software driven control system (15 and 16), a means of remote control (4), wherein a plurality of such heat generating systems are arranged in a local area network (7), the plurality of systems linked via connections (8), a heat distribution manifold to operate as a group with a master control system (16) associated with the software driven control system (15), whereby management of operation of the low and high temperature thermal stores (10, 11) can be arranged with priorities allowing the software driven control system (15) to override the master control system (16)-.

2. A heat generating system as claimed in claim 1, wherein the local control network (7) can be fitted with oversized high temperature thermal stores (10).

3. A heat generating system as claimed in claim 1, wherein the local control network (7) can be fitted with oversized low temperature thermal stores (11).

4. A heat generating system as claimed in claim 3, wherein the use of an oversized low temperature thermal store (11) enables a significant proportion of the energy capacity to be dedicated to remote control ensuring continuity of thermal supply to a building or process.

5. A heat generating system as claimed in claim 2, wherein the use of an oversized high temperature thermal store (10), enables a significant proportion of the energy capacity to be dedicated to remote control ensuring continuity of thermal supply to the building or process.

6. A heat generating system as claimed in claim 1, wherein the management of energy consumption from a distribution network (3) is executed by local machine control from the software driven control system (15).

7. A heat generating system as claimed in claim 6, wherein the management of energy consumption from the distribution network (3) is executed by remote control (4) from a grid control room (5).

8. (canceled)

9. A heat generating system as claimed in claim 1, wherein the local control network (7) comprises a series of air source heat pumps.

10. A heat generating system as claimed in claim 1, wherein the local control network (7) comprises a series of ground source heat pumps.

11. A heat generating system as claimed in claim 1, wherein the local control network (7) comprises a series of water source heat pumps.

12. A heat generating system as claimed in claim 1, wherein the means for remote control is a wireless or a physical connection.
